(19) United States
(12) Patent Application Publication
(10) Pub. No.: US 2016/0058137 A1
(43) Pub. Date: Mar. 3, 2016

(54) EYEGLASS HOLDER

(71) Applicant: Karen Prestwidge, Teaneck, NJ (US)

(72) Inventor: Karen Prestwidge, Teaneck, NJ (US)

(21) Appl. No.: 14/833,691

(22) Filed: Aug. 24, 2015

Related U.S. Application Data
(60) Provisional application No. 62/041,734, filed on Aug. 26, 2014.

(51) Int. Cl. A44C 15/00; G02C 3/04

(52) U.S. Cl. CPC A44C 15/003; G02C 3/04

(57) ABSTRACT

The present invention provides a device or holder for holding a pair of eyeglasses securely that may be incorporated into an assembly. The assembly features a hook, clasp, toggle, pin or clip and the device or holder for holding a temple piece of eyeglasses. The device or holder may be a tube formed of seed beads in a substantially cylindrical form having a first end and a second end and two substantially fixed linkers.

### FIELD OF THE INVENTION

The present invention provides a device or holder for a pair of eyeglasses. The device or holder suited to accept and hold a pair of eyeglasses may be joined to a necklace assembly for holding eyeglasses and that may be worn about the neck.

### BACKGROUND

Individuals wearing eyeglasses may wish to remove and replace them multiple times during the course of a day. After removing eyeglasses from the face, it is desirable to keep the eyeglasses nearby to be able to locate and replace them easily. Many eyeglass wearers often place the eyeglasses in a shirt or coat pocket or hang the eyeglasses from an opening of a shirt, sweater, jacket or blouse by inserting a temple piece inside the shirt, sweater, jacket or blouse. However, the eyeglasses may fall from such a position upon bending over. This is dangerous for both damaging and losing the eyeglasses.

Ward, U.S. Pat. No. 4,894,887 teaches an eyeglass carrier clip that may be clipped to a pocket for supporting a pair of eyeglasses by one of its temple pieces. The eyeglass carrier clip requires that the user wear a garment having a pocket suitable for clipping the device.

Grey, U.S. Pat. No. 5,305,934 teaches a tool and eyeglass holder that may be hung from the neck for holding eyeglasses and a screwdriver and spare screws for repairing the eyeglasses. The holders include a flexible cord or other elongated flexible member each end of which is either directly attached to a loop element or formed into a loop. The loops are respectively connected to corresponding loops at the ends of a tool container for the screwdriver and screws by interlocking the respective loops. A loop element is extended below the tool container for holding a pair of eyeglasses by inserting a temple piece of the eyeglasses through an aperture defined by the loop. Because of the interlocked loops connecting the flexible member to the tool container, the tool and eyeglass holder must be slipped over the head of the user in order to be hung about the neck.

De Cotis, U.S. Pat. No. 5,893,198 teaches a necklace assembly for holding a pair of eyeglasses that features an elongated flexible necklace for wearing about the neck and an eyeglass-holder assembly connected between the first and second ends of the necklace. The eyeglass-holder assembly includes an eyeglass-holder loop having a receiver loop opening adapted to receive a temple piece of a pair of eyeglasses. The assembly further features a first and second swivel linker connected to the necklace and to the holder-loop so that the necklace and the holder loop are rotatably joined. Further, the assembly features a necklace/holder-assembly coupler connecting the first end of the necklace with the swivel linker and a second necklace/holder-assembly coupler connecting the second end of the necklace with the swivel linker. The assembly may be worn about the neck with a pair of eyeglasses in a folded-closed configuration held in the eyeglass-holder loop of the eyeglass-holder assembly with a temple piece extending downwardly from one side of the temple-piece-receiver loop opening and a lens frame of the eyeglasses extending downwardly from an opposite side of the loop opening and with twisting induced in the necklace by movement of the wearer tending to be relieved by rotation of the swivel linkers. The receiver loop is a circle and it is free to rotate with respect to the necklace.

Prestwidge, U.S. Pat. No. 8,739,570 teaches a device or holder for holding a pair of eyeglasses securely that is incorporated into a necklace assembly. The device or holder features a flexible tube in a substantially cylindrical form having a first end and a second end, the cylindrical flexible tube is about 0.25″ to 1.00″ in length, and it is formed of stitched seed beads. The device of holder further features two substantially fixed linkers, a first linker linking the device or holder for holding a temple piece of eyeglasses to the first end of a necklace and a second linker linking the eyeglass holder device to the second end of a necklace. Also, the two substantially fixed linkers do not permit substantial rotation about an axis of the flexible tube with respect to the necklace.

It is desirable to provide an eyeglass holder designed to more securely hold a temple piece of eyeglasses. Further, it is desirable to provide an eyeglass holder and linker designed for substantially fixed attachment to a hook, clasp, toggle, pin or clip that does not rotate substantially with respect to the hook, clasp, toggle, pin or clip. Still further, it is desirable to provide an eyeglass holder that may be made of artistic and attractive beads providing a stylish alternative to eyeglass holders presently available.

### SUMMARY OF THE INVENTION

The present invention provides an assembly for holding a pair of eyeglasses featuring a hook, clasp, toggle, pin or clip and a device or holder for holding a temple piece of eyeglasses. The device or holder for holding a temple piece of eyeglasses is made of a tube formed of seed beads in a substantially cylindrical form having a first end and a second end. The tube features two or more substantially fixed linkers for attaching or liking the tube to a spacer or to the hook, clasp, toggle, pin or clip. In many instances, the two substantially fixed linkers do not permit substantial rotation about an axis of the tube with respect to the hook, clasp, toggle, pin or clip. The tube is in substantially cylindrical form having a first end and a second end and may be of any suitable size. For instance, the tube may be about 0.25″ to 1.00″ in length. The assembly for holding a pair of eyeglasses may further feature a spacer positioned between the tube and the hook, clasp, toggle, pin or clip. Still further, the assembly may feature a second linker for linking the spacer to an end of or a terminal loop of the hook, clasp, clip, pin or toggle. As such, in many instances, the hook, clasp, toggle, pin or clip has an end or a terminal loop. The spacer may be, for instance, a chain, loop, medallion or pendant.

As such, the present invention provides a device or holder for holding a pair of eyeglasses securely that may be incorporated into a hook, clasp, toggle, pin or clip assembly. In some embodiments, the holder or device for holding a pair of eyeglasses may be connected to a hook, clasp, toggle, pin or a clip having an end by a linker, one linker attached to the holder and adapted to attach to an end of a hook, clasp, toggle, pin or clip and optionally a second linker attached to the holder and adapted to attach to a second point on a hook, clasp, toggle, pin or clip. The end of the hook, clasp, toggle, pin or clip may have a first and/or a second terminal loop. There may be provided a spacer, such as, for instance, a chain or loop or medallion or pendant, between the end of the hook, clasp, toggle, pin or clip and the linker. The spacer may be of any suitable length, such, as for instance, 1, 2, 3, 4, 5 or more millimeters, and it may be of any suitable or desirable shape such as substantially square, rectangular, spherical, etc.

In other embodiments, the holder or device for holding a pair of eyeglasses may be connected to a hook, clasp, toggle, pin or clip without a linker. Such a direct connection between the holder or device for holding a pair of eyeglasses and the hook, clasp, toggle, pin or clip may be provided with, for instance, a crimp tube or with an adhesive such as, for instance, any suitable glue.

In still other embodiments, the holder or device for holding a pair of eyeglasses may be connected to or engaged with a hook, clasp, toggle, pin or clip that is in turn provided with a substantial clasp. Such an attachment or engagement may substantially place the holder or device for holding a pair of eyeglasses on a side of a wearer's chest, or on an article of clothing, such as, for instance, on a cuff, on a waistband, proximate a pocket or a belt loop or a button hole. Likewise, such an attachment or engagement may substantially place the holder or device for holding a pair of eyeglasses on a handbag, sports bag, tote, valise, on a strap, or inside a pocket. Optionally, such an attachment or engagement may provide a wearer the option of moving the holder or device for holding a pair of eyeglasses relative to the wearer's body, such as, for instance, to the waist or in a pocket when not in use. An attachment or engagement in such embodiments may feature a hook, clasp, toggle, pin or clip attached to or in engagement with a holder or device for holding a pair of eyeglasses in such a manner so that the holder or device for holding a pair of eyeglasses is less prominent relative to the hook, clasp, toggle, pin or clip or less noticeable relative to the hook, clasp, toggle, pin or clip. In such embodiments, the hook, clasp, toggle, pin or clip or the first and second end of the toggle or clip or the linker or the spacer may be threaded through the tube portion of the holder or device for holding a pair of eyeglasses from both the top and the bottom thereof substantially along the same line and secured either on opposite sides or looped through again and secured on the same side of the tube portion of the holder or device for holding a pair of eyeglasses.

The hook, clasp, toggle, pin or clip assembly of the invention may comprise a hook, toggle, clasp, pin or clip for attaching or affixing to an article of clothing or accessory or a portion thereof, such as, for instance a pocket, belt loop, button hole, handbag, sports bag, tote, valise, etc. or on a strap or inside pocket of an accessory, so that the device or holder for holding a temple piece of eyeglasses may be worn about or affixed to the article of clothing or accessory. The device or holder for holding a temple piece of eyeglasses may include an eyeglass-holder tube and a first and a second linker. The eyeglass-holder tube of the device or holder for holding a temple piece of eyeglasses may have a temple-piece-receiver tube opening which is shaped and sized to receive a temple piece of a pair of eyeglasses. Each linker of the device or holder for holding a temple piece of eyeglasses may have a side connector and a side designed to connect to the device or holder for holding a temple piece of eyeglasses for connecting the device or holder to the hook, clasp, toggle, pin or clip. Each linker may be substantially fixed to the device or holder for holding a temple piece of eyeglasses so as to substantially prevent or inhibit rotation of the linker with respect to the device or holder for holding a temple piece of eyeglasses. A first and optionally a second terminal loop of the hook, clasp, toggle, pin or clip may be provided on the first end of the hook, clasp, toggle or clip and optionally the second end of the hook, clasp, toggle or clip so as to provide connection between the linkers and the first and optionally a second end of the hook, clasp, toggle, pin or clip.

The hook, clasp, toggle, pin or clip assembly of the invention may be, for instance, worn about the neck, attached to an article of clothing, such as, for instance, a pocket, collar, belt loop, or button hole, of a wearer with a pair of eyeglasses in a folded, substantially closed configuration removable and pendulously held in the device or holder for holding a temple piece of eyeglasses assembly with a temple piece extending downwardly from one side of the device or holder for holding a temple piece of eyeglasses opening and a lens frame of the eyeglasses extending downwardly from an opposite side of the device or holder for holding a temple piece of eyeglasses opening. The hook, clasp, toggle, pin or clip assembly of the invention may operate to retain the eyeglasses securely in the device or holder for holding a temple piece of eyeglasses of the assembly as the wearer moves about or bends over. Advantageously, twisting or kinking of the hook, clasp, toggle, pin or clip of the hook, clasp, toggle, pin or clip assembly of the invention induced by movement of the wearer is minimized so that the hook, clasp, toggle, pin or clip assembly tends to lie substantially flatly and neatly on the wearer when the wearer stands or sits upright.

Preferably, the eyeglass holder device for holding a temple piece of eyeglasses of the hook, clasp, toggle or clip assembly is substantially in the shape of a tube. The substantially tube shaped eyeglass holder device preferably has a diameter in the range of from about 0.2 to 2.0 or 0.4 to 1.5 inches, with a diameter of about 0.5 inches being particularly preferred. Preferably, the hook, clasp, toggle, pin or clip of the invention is in the form of or has the appearance of a piece of jewelry. Further, the eyeglass holder device preferably is substantially flexible so as to provide superior gripping and securing of the eyeglasses. As such, the eyeglass holder device may be made of any suitable material, such as, for instance, threaded or sewn seed beads. The seed beads may be made of any suitable material such as, for instance, metal, wood, ceramic, porcelain, glass or crystal.

### BRIEF DESCRIPTION OF THE DRAWINGS

Preferred embodiments of the device or holder for holding a temple piece of eyeglasses and the hook, clasp, toggle or clip assembly of the invention are described below with reference to the following figures:

FIG. 1 is a front view of a device or holder for holding a temple piece of eyeglasses.

FIG. 2 is a top or bottom view of a device or holder for holding a temple piece of eyeglasses.

FIG. 3 is a clip assembly 5 having a device or holder for holding a temple piece of eyeglasses 1 linked by two fixed first linkers 9, 10, one linker linking the device or holder for holding a temple piece of eyeglasses to a first point on a clip 6 and a second linker linking the device or holder for holding a temple piece of eyeglasses to a second point on the clip 6. The device or holder for holding a temple piece of eyeglasses 1 may be substantially permanently affixed to the clip 6 on a side thereof with, for instance, a glue. The device or holder for holding a temple piece of eyeglasses 1, two first linkers, 9, 10, and clip 6 together form a clip assembly 5.

FIG. 4 is a clasp assembly 5 having a device or holder for holding a temple piece of eyeglasses 1 linked by two fixed first linkers 9, 10, one linker linking the device or holder for holding a temple piece of eyeglasses to a first point on a spacer 12 and a second first linker linking the device or holder for holding a temple piece of eyeglasses to a second point on the spacer 12. The spacer 12 is then linked via a second linker 13 to an end or terminal loop of the clasp 11 so that the device or holder for holding a temple piece of eyeglasses 1, two first linkers, 9, 10, spacer 12, second linker 13 and clasp 7 having an end or terminal loop 11 together form a clasp assembly 5.

FIG. 5 is a hook assembly 5 having a device or holder for holding a temple piece of eyeglasses 1 linked by two fixed first linkers 9, 10, one linker linking the device or holder for holding a temple piece of eyeglasses 1 a first point on a spacer 12 and a second linker linking the device or holder for holding a temple piece of eyeglasses to a second point on the spacer 12. The spacer 12 is then linked via a linker 13 to an end or terminal loop of the clasp 11 so that the device or holder for holding a temple piece of eyeglasses 1, two first linkers, 9, 10, spacer 12, second linker 13 and hook 8 having an end or terminal loop 11 together form a hook assembly 5.

FIG. 6 is another clasp assembly 5 having a device or holder for holding a temple piece of eyeglasses 1 linked by two fixed first linkers 9, 10, one linker 9 linking the device or holder for holding a temple piece of eyeglasses to a spacer 12 and a second linker 10 linking the device or holder for holding a temple piece of eyeglasses to a terminal loop of the clasp 11 so that the device or holder for holding a temple piece of eyeglasses 1, two linkers, 9, 10, spacer 12, and clasp 7 having an end or terminal loop 11 together form a clasp assembly 5.

FIG. 7 is yet another clasp assembly 5 having a device or holder for holding a temple piece of eyeglasses 1 linked by two fixed first linkers 9, 10, one linker 9 linking the device or holder for holding a temple piece of eyeglasses to a spacer 12 and a second linker 10 linking the device or holder for holding a temple piece of eyeglasses to a terminal loop of the clasp 11 so that the device or holder for holding a temple piece of eyeglasses 1, two linkers, 9, 10, spacer 12, and clasp 7 having an end or terminal loop 11 together form a clasp assembly 5.

FIG. 8 is yet another front view of a device or holder for holding a temple piece of eyeglasses 1 having an opening at each end, and opening at a first end 2, and an opening at a second end 3 and having an opening or tubular hole 4 therethrough.

### DETAILED DESCRIPTION OF THE PREFERRED EMBODIMENTS

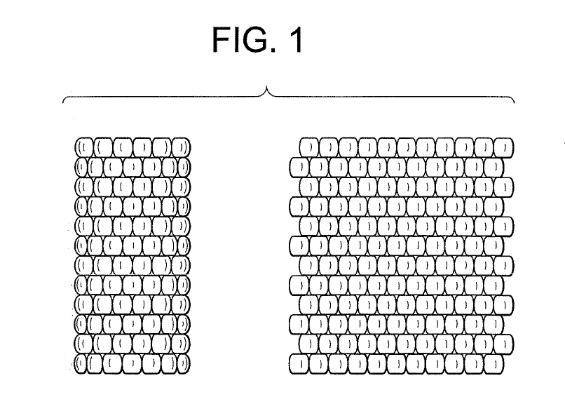

Turning to FIG. 1, a device or holder for holding a temple piece of eyeglasses 1 is provided with a tube in a substantially cylindrical form that may be elongated in shape and having an opening at each end, and opening at a first end 2, and an opening at a second end 3. The eyeglass holder device may be formed of any material amenable to being formed into a sheet and connected together into a substantially cylindrical form, such as, for example, seed beads stitched together. Such a fabrication provides for superior flexibility and provides for superior clasping of the temple piece of eyeglasses.

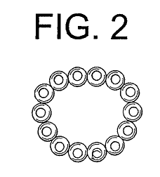

FIG. 2 provides a top or a bottom view of the device or holder for holding a temple piece of eyeglasses 1 in a substantially cylindrical form that may be elongated in shape and having an opening at each end, and opening at a first end 2, and an opening at a second end 3.

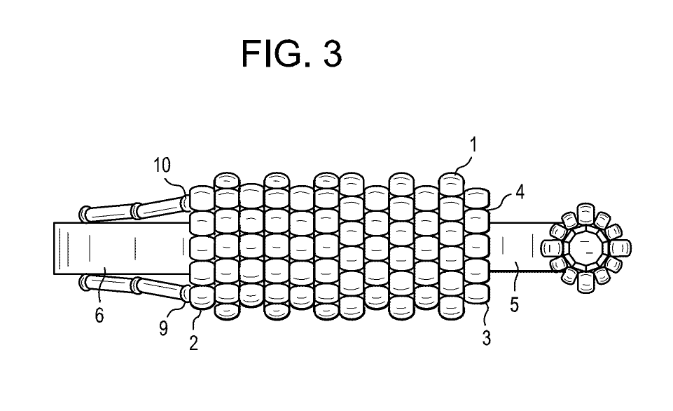

FIG. 3 illustrates a hook, clasp, toggle or clip assembly 5 having a device or holder for holding a temple piece of eyeglasses 1 attached to or in engagement with a clip 6, or both, so that the device or holder for holding a temple piece of eyeglasses 1 and clip 6 together form a clip assembly 5. The clip assembly 5 having a device or holder for holding a temple piece of eyeglasses 1 may be optionally linked by two fixed first linkers 9, 10, one linker linking the device or holder for holding a temple piece of eyeglasses to a first point on a clip 6 and a second linker linking the device or holder for holding a temple piece of eyeglasses to a second point on the clip 6. The device or holder for holding a temple piece of eyeglasses 1 may be substantially permanently affixed to the clip 6 on a side thereof with, for instance, a glue. The device or holder for holding a temple piece of eyeglasses 1, two first linkers, 9, 10, and clip 6 together form a clip assembly 5.

The clip assembly 5 for holding a pair of eyeglasses includes a clip 6 that may be adapted for fastening to an article of clothing by clipping, pinning or via engagement with a fastener or tack through a button hole or through the material or cloth of the article of clothing directly. The clip 6 and/or clip assembly 5 may be or may form an ornamental piece of jewelry having beads, pendants, crystals and the like attached thereto or entwined therein. For example, a clip 6 may be made of gold, silver or other precious metal or of a mock-tortoise-shell or mock-ivory plastic material.

The device or holder for holding a temple piece of eyeglasses 1 may connected to the clip 6 via terminal first linkers 9 and 10. The device or holder for holding a temple piece of eyeglasses 1 may connected to the clip 6 via a substantially permanent bond, such as, for instance, glue. The eyeglass-holder assembly then includes a device or holder for holding a temple piece of eyeglasses.

A central opening 4, defined by a top end and a bottom end, 2 and 3 of the device or holder for holding a temple piece of eyeglasses 1 of the hook, clasp, toggle or clip assembly 5 defines an opening for receiving a temple piece of eyeglasses. The temple piece of the eyeglasses may be inserted into the central opening 4 via the top end 2 or the bottom end 3, so that the eyeglasses may be held in a folded closed configuration that is held substantially in place by the device or holder for holding a temple piece of eyeglasses 1. As a result, the eyeglasses remain in place in a pendulous position on the chest or abdomen of the wearer or proximate to or lying upon an article of clothing or portion of the same such as, for instance, a belt loop, pocket, button hole, collar, etc.

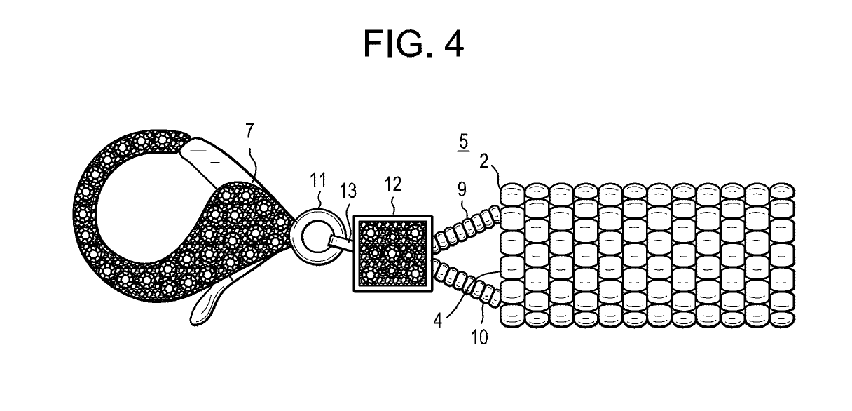

FIG. 4 illustrates a clasp assembly 5 having a device or holder for holding a temple piece of eyeglasses 1 linked by two fixed first linkers 9, 10, one linker linking the device or holder for holding a temple piece of eyeglasses to a first point on a spacer 12 and a second linker linking the device or holder for holding a temple piece of eyeglasses to a second point on the spacer 12. The spacer 12 is then linked via a second linker 13 to an end or terminal loop of the clasp 11 so that the device or holder for holding a temple piece of eyeglasses 1, two first linkers, 9, 10, spacer 12, second linker 13 and clasp 7 having an end or terminal loop 11 together form a clasp assembly 5.

The first linkers 9, 10 and second linker 13 as well as the spacer 12 may be formed of a jewelry chain made of gold, silver or other precious metal or of a mock-tortoise-shell or mock-ivory plastic material or beads. The spacer 12 may be a pendant, medallion, jewel, chain, loop or other ornamental object. The first linkers 9 and 10 and optionally the second linker 13 may be designed so as not to permit rotation about an axis. As may be seen in FIG. 4, the first linkers 9 and 10 may connect to a single or proximate point on the spacer 12.

A central opening 4, defined by a top end and a bottom end, 2 and 3 of the device or holder for holding a temple piece of eyeglasses 1 of the hook, clasp, toggle or clip assembly 5 defines an opening for receiving a temple piece of eyeglasses. The temple piece of the eyeglasses may be inserted into the central opening 4 via the top end 2 or the bottom end 3, so that the eyeglasses may be held in a folded closed configuration that is held substantially in place by the device or holder for holding a temple piece of eyeglasses 1. As a result, the eyeglasses remain in place in a pendulous position on the chest or abdomen of the wearer or proximate to or lying upon an article of clothing or portion of the same such as, for instance, a belt loop, pocket, button hole, collar, etc.

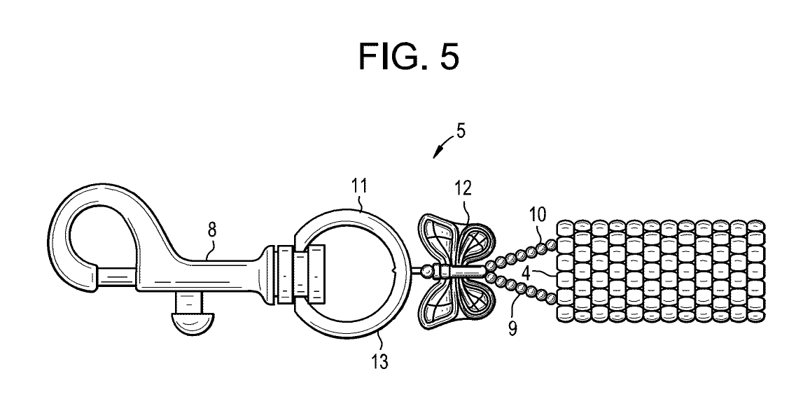

FIG. 5 illustrates a hook assembly 5 having a device or holder for holding a temple piece of eyeglasses 1 linked by two fixed first linkers 9, 10, one linker linking the device or holder for holding a temple piece of eyeglasses 1 a first point on a spacer 12 and a second linker linking the device or holder for holding a temple piece of eyeglasses to a second point on the spacer 12. The spacer 12 is then linked via a second linker 13 to an end or terminal loop of the clasp 11 so that the device or holder for holding a temple piece of eyeglasses 1, two first linkers, 9, 10, spacer 12, second linker 13 and hook 8 having an end or terminal loop 11 together form a hook assembly 5.

The first linkers 9, 10 and second linker 13 as well as the spacer 12 may be formed of a jewelry chain made of gold, silver or other precious metal or of a mock-tortoise-shell or mock-ivory plastic material or beads. The spacer 12 may be a pendant, medallion, jewel, chain, loop or other ornamental object. The first linkers 9 and 10 and optionally the second linker 13 may be designed so as not to permit rotation about an axis. As may be seen in FIG. 5, the first linkers 9 and 10 may connect to a single or proximate point on the spacer 12.

A central opening 4, defined by a top end and a bottom end, 2 and 3 of the device or holder for holding a temple piece of eyeglasses 1 of the hook, clasp, toggle or clip assembly 5 defines an opening for receiving a temple piece of eyeglasses. The temple piece of the eyeglasses may be inserted into the central opening 4 via the top end 2 or the bottom end 3, so that the eyeglasses may be held in a folded closed configuration that is held substantially in place by the device or holder for holding a temple piece of eyeglasses 1. As a result, the eyeglasses remain in place in a pendulous position on the chest or abdomen of the wearer or proximate to or lying upon an article of clothing or portion of the same such as, for instance, a belt loop, pocket, button hole, collar, etc.

The device or holder for holding a temple piece of eyeglasses provides a substantial sleeve or tube through which a temporal piece of eyeglasses may be placed and secured. The device or holder for holding a temple piece of eyeglasses may be substantially flexible so as to provide improved gripping and securing of a temporal piece of the eyeglasses and may formed of any suitable material such as, for instance, fabric, plastic, rubber or seed beads such as #8 seed beads. The seed beads may be made of glass, plastic, metal, wood, crystal, etc. or any suitable material. The eyeglass holder device may be, for instance, made from opalescent clear beads with an upper and lower border of opalescent silver or opalescent gold beads. The eyeglass holder device made of such beads may be formed in, for instance, a 1.38″×1.13″ peyote-stitched mat, using, for instance, a 12×22 bead pattern. It may then be zipped closed to form a flexible tube of, for instance, 0.5″ diameter tube, 1.13″ in length. There are many suitable sizes, such as, for instance a 0.25-1.0″ in tube diameter, 0.30-0.80″ in tube diameter, 0.40-0.80″ in tube diameter, or 0.50-0.75″ in tube diameter. The eyeglass holder device may be, for instance at least about 0.25″, 0.50″, 0.75″, 1.00″, 1.10″, 1.20″, 1.25″, 1.30″, 1.40″, 1.50″, 1.75″ or 2.0″ or more in length.

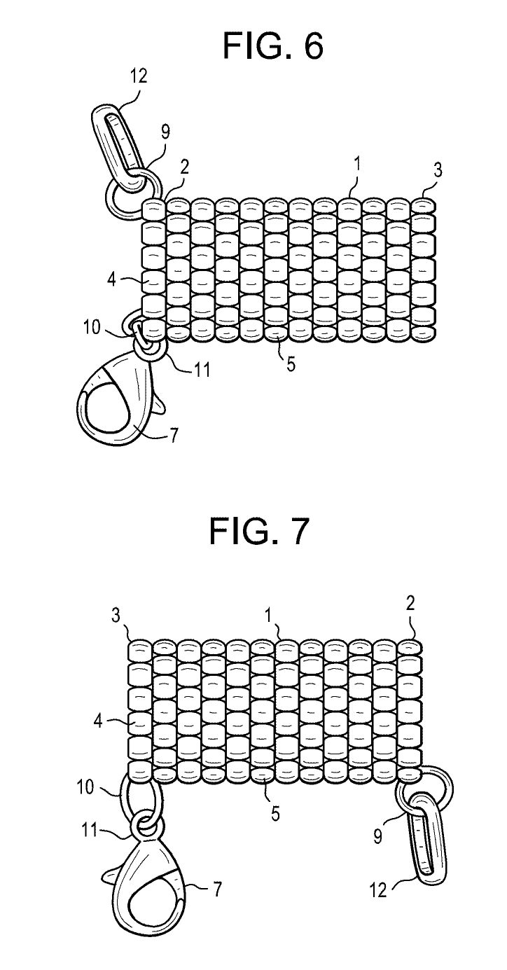

FIG. 6 is another clasp assembly 5 having a device or holder for holding a temple piece of eyeglasses 1 linked by two fixed first linkers 9, 10, one linker 9 linking the device or holder for holding a temple piece of eyeglasses to a spacer 12 and a second linker 10 linking the device or holder for holding a temple piece of eyeglasses to a terminal loop of the clasp 11 so that the device or holder for holding a temple piece of eyeglasses 1, two linkers, 9, 10, spacer 12, and clasp 7 having an end or terminal loop 11 together form a clasp assembly 5. Such an assembly is similar to that of FIG. 4, but the clasp 7 is substantially smaller thereby more readily adaptable to different sized articles of clothing, accessories or portions thereof.

FIG. 7 is yet another clasp assembly 5 having a device or holder for holding a temple piece of eyeglasses 1 linked by two fixed first linkers 9, 10, one linker 9 linking the device or holder for holding a temple piece of eyeglasses to a spacer 12 and a second linker 10 linking the device or holder for holding a temple piece of eyeglasses to a terminal loop of the clasp 11 so that the device or holder for holding a temple piece of eyeglasses 1, two linkers, 9, 10, spacer 12, and clasp 7 having an end or terminal loop 11 together form a clasp assembly 5. Such an assembly is similar to that of FIGS. 4 and 6, however, the linkers, 9, 10 are positioned at opposite ends of the device or holder for holding a temple piece of eyeglasses 1 with respect to the long ends, not with respect to the width of the ends.

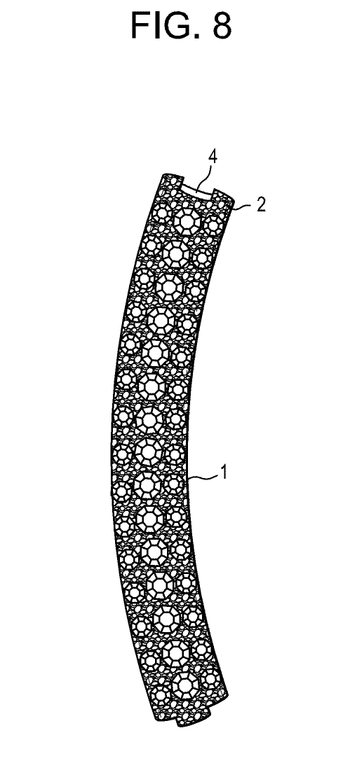

FIG. 8 is yet another front view of a device or holder for holding a temple piece of eyeglasses 1 having an opening at each end, and opening at a first end 2, and an opening at a second end 3 and having an opening or tubular hole 4 therethrough.

It is not intended to limit the present invention to the specific embodiments described above. For example, the eyeglass-holder device of the eyeglass-holder assembly of the hook, clasp, toggle or clipassembly of the invention may be of any suitable shape or size or made of any suitable material. Jewelry chains or beads of any suitable size, shape or style may be used for the linkers 9, 10, and optionally 13 of the invention. The spacers 12 may likewise be of any suitable shape, size, material or ornamentation. Any part or all of the assembly described herein may represent or form a piece of jewelry or ornamentation. It is recognized that these and other changes may be made in the hook, clasp, toggle or clip assembly of the invention specifically described herein without departing from the scope and teachings of the invention. The present invention is intended to encompass all embodiments, alternatives, and modifications consistent herewith.

I claim:

1. An assembly for holding a pair of eyeglasses comprising:
(a) a hook, clasp, toggle, pin or clip; and
(b) a device or holder for holding a temple piece of eyeglasses comprising:
i) a tube formed of seed beads in a substantially cylindrical form having a first end and a second end; and
ii) two or more substantially fixed linkers.

2. An assembly for holding a pair of eyeglasses according to claim 1 wherein the two substantially fixed linkers do not permit substantial rotation about an axis of the tube with respect to the hook, clasp, toggle or clip.

3. An assembly for holding a pair of eyeglasses according to claim 1 wherein the tube in a substantially cylindrical form having a first end and a second end is about 0.25″ to 1.00″ in length.

4. An assembly for holding a pair of eyeglasses according to claim 1 wherein (a) is a hook.

5. An assembly for holding a pair of eyeglasses according to claim 1 wherein (a) is a clasp.

6. An assembly for holding a pair of eyeglasses according to claim 1 wherein (a) is a toggle.

7. An assembly for holding a pair of eyeglasses according to claim 1 wherein (a) is a clip.

8. An assembly for holding a pair of eyeglasses according to claim 1 wherein (a) is a pin.

9. An assembly for holding a pair of eyeglasses according to claim 1 further comprising a spacer.

10. An assembly for holding a pair of eyeglasses according to claim 1 further comprising a second linker for linking a spacer to an end of or a terminal loop of the hook, clasp, pin or toggle.

11. An assembly for holding a pair of eyeglasses according to claim 4 wherein the hook comprises an end or a terminal loop.

12. An assembly for holding a pair of eyeglasses according to claim 5 wherein the clasp comprises an end or a terminal loop.

13. An assembly for holding a pair of eyeglasses according to claim 7 wherein the device or holder for holding a temple piece of eyeglasses is substantially permanently affixed to the clip.

14. An assembly for holding a pair of eyeglasses according to claim 8 wherein the spacer is a chain, loop, medallion or pendant.
